(19) United States
(12) Patent Application Publication
(10) Pub. No.: US 2006/0002554 A1
(43) Pub. Date: Jan. 5, 2006

(54) Apparatus for controlling chaos using oscillation quenching

(76) Inventors: Chil Min Kim, Daedeok-Gu (KR); Dae Sic Lee, Seo-Gu (KR); Jung Wan Ryu, Seo-gu (KR)

Correspondence Address: FISH & RICHARDSON P.C., P.O. BOX 1022, MINNEAPOLIS, MN, 55440-1022, US

(21) Appl. No.: 11/170,070

(22) Filed: Jun. 30, 2005

(30) Foreign Application Priority Data
Jun. 30, 2004 (KR) 10-2004-0050903

(51) Int. Cl. H04L 9/00

(52) U.S. Cl. 380/263

(57) ABSTRACT

The present invention relates to an apparatus for controlling chaos using oscillation quenching, and more particularly, to an apparatus for controlling chaos using oscillation quenching, wherein a chaos system to be controlled can be easily stabilized by coupling the chaos system with another chaos system or a periodic system that can be easily implemented, using the concept of oscillation quenching. To this end, the present invention provides an apparatus for controlling chaos using oscillation quenching, comprising a chaos signal generating device 10 for generating a chaos signal; a first scaling means 40 for scaling an output signal from a controlled chaos device; a second scaling means 20 for scaling an output signal from the chaos signal generating device 10; a subtraction means 50 for performing a subtraction operation between the output signals of the first and second scaling means 40 and 20; an auxiliary scaling means 60 for scaling an output signal from the subtraction means 50 so that a coupling constant for the controlled chaos device 30 and the chaos signal generating device 10 is in a state where chaos is stabilized, and for feeding back the scaled signal to the controlled chaos device 30; and an inverting means 70 for inverting an output signal from the auxiliary scaling means 60 and feeding back the inverted signal to the chaos signal generating device 10.

### BACKGROUND OF THE INVENTION

1. Field of the Invention

The present invention relates to an apparatus for controlling chaos using oscillation quenching, and more particularly, to an apparatus for controlling chaos using oscillation quenching, wherein a chaos system to be controlled can be easily stabilized by coupling the chaos system with another type of chaos system or another linear oscillator that can easily be implemented, using the concept of oscillation quenching.

2. Description of the Related Art

With the recent intensive interest in ‘chaos,’ studies on applying the chaos to various industrial fields have been actively performed. As known well, ‘chaos’ used herein refers to one of complicated physical phenomena occurring in nonlinear dynamical systems. Even though two chaos systems having the same configuration have a very slight difference between their initial conditions, they exhibit highly different aspects over time and thus have unpredictable properties. The sensitivity of a chaos system to initial conditions is called ‘butterfly effect.’

Meanwhile, even in physical systems in which periodic operations are required, nonlinear elements existing in the physical systems may often cause unwanted chaos. That is, most physical systems such as electronic circuits, laser, fluid, and hydrodyanmic system have an area where its operation property exhibits periodicity and an area where its operation property exhibits chaos. Normally, operation conditions have been strictly limited such that the physical systems operate only in the area where the periodic property is exhibited. For example, if the output of a physical system, which should be constant, suddenly causes very irregular chaos like noise due to adjustment of a parameter, the physical system cannot be used in such an area of the parameter.

With continuous studies on the chaos, there have been proposed various methods capable of stabilizing chaos that have been believed as being uncontrollable. Consequently, the operation range of a physical system of which operation range has been limited can be expanded, whereby very useful advantages are obtained in industries.

In a conventional method of controlling chaos, chaos is controlled using a periodic signal. In general, the chaos is stabilized to an unstable periodic orbit existing within a chaos attractor. This requires an analysis of the chaos attractor to find a period or to obtain an unstable periodic orbit within the chaos attractor. Further, several control variables required for control should be found. However, it has been known that this method is very difficult to be used in an actual system. First, if there is noise in the chaos attractor, a new task for eliminating the noise is required. If the property of output of chaos is slightly changed due to changes in the state of a chaos system, a new control variable to be controlled should be found, resulting in complication. Further, although the use of a periodic signal can stabilize the system, control may be considerably complicated to stabilize to an unstable fixed point.

### SUMMARY OF THE INVENTION

The present invention is conceived to solve the aforementioned problems. An object of the present invention is to provide an apparatus for controlling chaos using oscillation quenching, wherein a chaos system to be controlled can be easily stabilized by coupling the chaos system with another chaos system or another periodic system that can be easily implemented, using the concept of oscillation quenching.

According to the present invention for achieving the object, there is provided an apparatus for controlling chaos using oscillation quenching, comprising a chaos signal generating device for generating a chaos signal 10; a first scaling means 40 for scaling an output signal from a controlled chaos device; a second scaling means 20 for scaling an output signal from the chaos signal generating device; a subtraction means 50 for performing a subtraction operation between the output signals of the first and second scaling means 40 and 20; an auxiliary scaling means 60 for scaling an output signal from the subtraction means so that a coupling constant for the controlled chaos device 30 and the chaos signal generating device is in a state where chaos is stabilized, and for feeding back the scaled signal to the controlled chaos device 30; and an inverting means 70 for inverting an output signal from the auxiliary scaling means 60 and feeding back the inverted signal to the chaos signal generating device.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a block diagram of an apparatus for controlling chaos using oscillation quenching according to the present invention;

FIG. 2 is a diagram illustrating changes in chaos according to increases in the value of a coupling constant for two chaos devices;

FIG. 3 is a diagram showing an area where chaos is stabilized when the two chaos devices are coupled;

FIG. 4 illustrates an embodiment in which an apparatus for controlling chaos using oscillation quenching according to the present invention is applied to an Nd:YAG laser;

FIG. 5 is graphs showing waveforms when chaos is controlled in FIG. 4; and

FIG. 6 is diagrams illustrating controlled patterns of chaos according to a coupling constant in FIG. 4.

### DETAILED DESCRIPTION OF THE PREFERRED EMBODIMENTS

Hereinafter, a preferred embodiment of the present invention will be described with reference to the accompanying drawings.

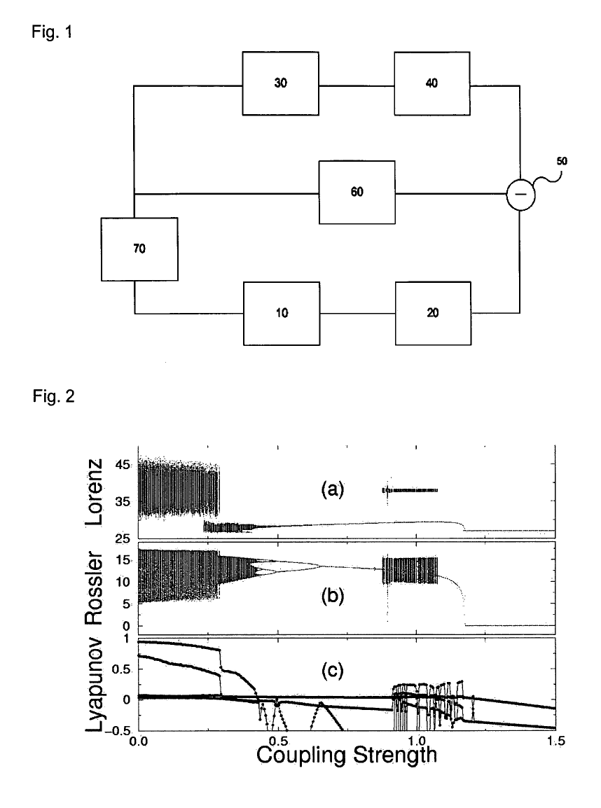

FIG. 1 is a block diagram of an apparatus for controlling chaos using oscillation quenching according to the present invention.

Referring to FIG. 1, the apparatus for controlling chaos comprises the first scaling means 20 for scaling a chaos signal generated by a chaos signal generating device 10, a second scaling means 40 for scaling an output signal of a controlled chaos device 30, a subtraction means 50 for deriving a difference between two signals output from the first scaling means 20 and the second scaling means 40, an auxiliary scaling means 60 for scaling an output signal of the subtraction means 50 so that a coupling constant for the controlled chaos device 30 and the chaos signal generating device 10 is in a state where chaos is stabilized and for feeding back the scaled signal to the controlled chaos device 30, and an inverting means 70 for inverting the signal from the auxiliary scaling means 60.

The first scaling means 40 and the second scaling means 20 perform scaling such that the ratio of amplitudes of respective input signals is subjected to chaos quenching. The auxiliary scaling means 60 performs scaling such that a biased signal of the output signal from the subtraction means 50 is subjected to chaos quenching.

Even though the chaos signal generating device 10 may be replaced with a periodic signal generating device that generates a periodic signal, the same function and effects can be obtained.

A method of stabilizing chaos in a chaos system by coupling two chaos systems to each other will be described in detail below in connection with equations with a Lorenz chaos system and a Rossler chaos system coupled to each other. Coupling the Lorenz chaos system and the Rossler chaos system to each other results in the following equations:
\dot{x}=10(y−x),
\dot{y}=28x−y−xz,
\dot{z}=− 8/3z+xy+ε(\tilde{p}−\tilde{z}), Lorenz
\dot{p}=α(−ωq−r)+ε(\tilde{z}−\tilde{p}),
\dot{q}=α(ωp+0.15q),
\dot{r}=α(0.2+r(p−10.0)), Rossler,
where all of x, y, z, p, q and r are variables, α is a time scaling value, ε is a coupling constant for two chaos systems, and \tilde{p} and \tilde{z} are \tilde{p}=p−0.003 and \tilde{z}=z−28.0, respectively, and have no DC value. In the coupling, \tilde{p} and \tilde{z} are selected as variables so that there is no change in coefficients even when the two chaos systems converge to a fixed value by means of oscillation quenching.

Since the coupling of two chaos systems means that two chaos systems with different chaos properties are coupled to each other, the form of chaos becomes complicated. In such a chaos-coupled form, however, the chaos system exhibits a unique phenomenon in which as chaos disappears and convergence to a fixed value occurs when the coupling constant is very large. This phenomenon is similar to an oscillation quenching phenomenon that appears when the difference in coefficient between two chaos systems in the same coupled chaos system is large. To show the oscillation quenching phenomenon appearing in this system, a bifurcation architecture was obtained with α=8.087 and according to the value of a coupling constant.

FIG. 2 is a diagram illustrating changes in chaos according to increases in the value of a coupling constant for two chaos devices. Referring to FIG. 2, the equations converge to a fixed point if the value of a coupling constant is not less than 1.2, whereas the chaos signal is converted into a periodic signal through inverse bifurcation if the value of a coupling constant is less 1.2. Further, if the value of a coupling constant is not less than 2.3, the two chaos systems suddenly lose their stability and undergo a transition to chaos. In this case, however, a periodic signal area or a fixed point area can be used as one of chaos control means. From the analysis results, it can be seen that if any system exhibits chaos, the system can be conveniently stabilized by coupling any chaos system thereto.

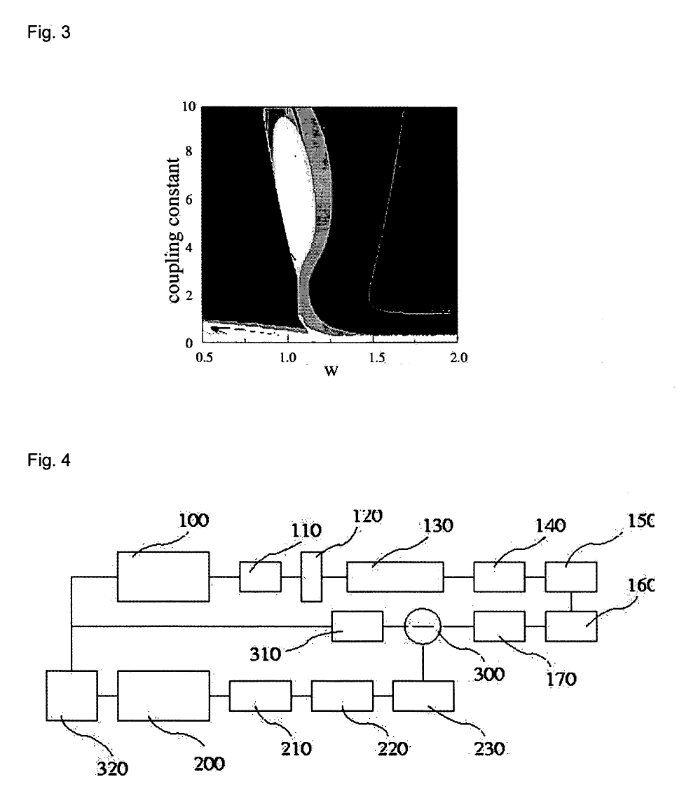

FIG. 3 is a diagram showing an area where chaos is stabilized when the two chaos devices are coupled.

Referring to FIG. 3, to check how wide a fixed point area is, a fixed point area can be obtained according to the strength of a coupling force and the α value. FIG. 3 shows an area where chaos converges to a fixed point. It can be seen from this figure that if there is great difference in frequency between the two chaos systems and a coupling force is strong, the two chaos systems converge to the fixed point over a very wide area. It can be also seen from this figure that coupling the Lorenz chaos system to the Rossler chaos system, which are different chaos systems, makes it possible to easily stabilize the two chaos systems into the fixed point.

FIG. 4 illustrates an embodiment in which the apparatus for controlling chaos using oscillation quenching according to the present invention is applied to an Nd:YAG laser.

It was found that when the chaos controlling apparatus of the present invention is applied to an Nd:YAG laser excited by an actual diode laser, chaos in the laser is stabilized. A laser generally outputs an irregular signal. The application of the laser to a precise operation is partially limited due to this irregular signal. For the application to the precise operation, the output of the laser should be stabilized. Accordingly, a complicated optical method is used to stabilize the laser. The application of the chaos controlling apparatus of the present invention to a laser easily stabilizes the unstable output of the laser, thereby making it possible to efficiently control the laser.

A diode current supplier 100 supplies a current to a diode laser 110 that in turn oscillates a laser beam of about 808 nm. A lens 120 focuses the laser beam and projects it on an Nd:YAG laser 130. The Nd:YAG laser then outputs a laser beam of about 1064 nm. A rear portion of the laser rod is coated so that a beam of about 808 nm is transmitted therethrough and a beam of about 1064 nm is totally reflected thereon. A half mirror with a reflectance of 97% is used as a laser output mirror. An optical sensor 140 receives the beam output from the laser and converts the beam into a voltage. This signal is cause to pass through a differentiator 150 and an integrator 160, thereby eliminating a DC component of the signal. An amplifier 170 amplifies the signal to have a suitable amplitude. A Rossler chaos system 200 implemented by an electronic circuit was used as another chaos system. A chaos signal coming from the chaos system is caused to pass through a differentiator 210 and an integrator 220, thereby eliminating a DC component of the chaos signal. An amplifier 230 amplifies the signal that has no DC component. A subtractor 300 obtains a difference between the chaos signal coming from the laser and the amplified signal, and a scaling means 310 scales the difference signal and inputs the scaled signal to the diode laser current supplier 100 and to an inverter 320. An inverted signal that is obtained by inverting the signal from the scaling means 310 through the inverter 320 is input back to the Rossler chaos system 200 implemented by an electronic circuit.

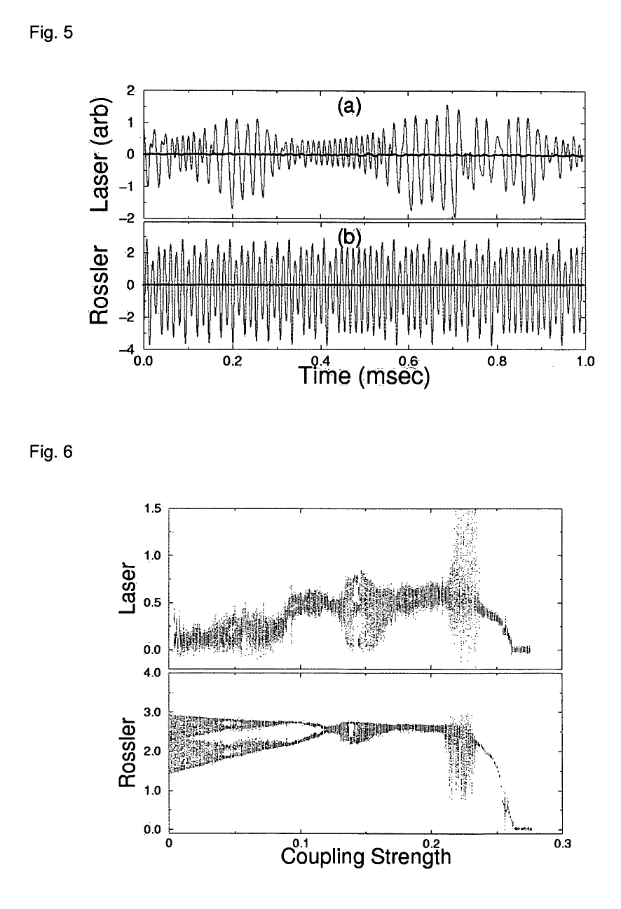

FIG. 5 shows a waveform of the chaos signal from the laser and a waveform of the chaos signal from the Rossler chaos system that is implemented by an electronic circuit. FIG. 5 (a) shows the waveform of the laser and FIG. 5 (b) shows the waveform of the signal from the electronic circuit type Rossler chaos system. First, when the two chaos systems are not coupled to each other, the two chaos systems output irregular waveforms as shown in the figures. However, when the two chaos systems are coupled to each other and the scaling of the scaling unit 310 is then set to 95%, the two chaos systems exhibit the stabilized waveforms as indicated by solid bold lines in the figures. These waveforms are chaos-stabilized waveforms obtained by coupling the two chaos systems. In this case, the average output of the laser is not reduced at all.

In an actual chaos system, it was examined whether chaos is stabilized, by using a bifurcation diagram according to the value of a coupling constant. FIG. 6 shows bifurcation diagrams according to the value of a coupling constant. FIG. 6 (a) shows a bifurcation diagram of a laser and FIG. 6 (b) shows a bifurcation diagram of an electronic circuit of Rossler chaos system. Referring to the figures, the two chaos systems undergo transition of a chaos state to a stabilized state by inverse period-doubling bifurcation. It can be seen that the two chaos systems converge to fixed points and exhibit stabilized waveforms in an area where the value of a coupling constant is greater than 0.92, whereas regular signals with various periods are generated in an area preceding the area.

As described above, the present invention provides an apparatus for controlling chaos, wherein a chaos system to be controlled can be easily stabilized by coupling the chaos system with another chaos system that has been already implemented, using the concept of oscillation quenching. Therefore, there is an advantage in that the chaos system to be controlled can be simply and easily stabilized.

Although the present invention has been described in connection with a preferred embodiment thereof, it will be understood by those skilled in the art that various modifications and changes can be made thereto without departing from the scope of the present invention defined by the appended claims. Therefore, such modifications and changes fall within the scope of the present invention.

What is claimed is:

1. An apparatus for controlling chaos using oscillation quenching, comprising:
a chaos signal generating device (10) for generating a chaos signal;
the first scaling means (40) for scaling an output signal from a controlled chaos device (30);
the second scaling means (20) for scaling an output signal from the chaos signal generating device (10);
a subtraction means (50) for performing a subtraction operation between the output signals of the first and second scaling means (40) and (20);
an auxiliary scaling means (60)for scaling an output signal from the subtraction means (50) so that a coupling constant for the controlled chaos device (30) and the chaos signal generating device (10) is in a state where chaos is stabilized, and for feeding back the scaled signal to the controlled chaos device (30); and
an inverting means (70) for inverting an output signal from the auxiliary scaling means (60) and feeding back the inverted signal to the chaos signal generating device (10).

2. An apparatus for controlling chaos using oscillation quenching, comprising:
a periodic signal generating device (10) for generating a periodic signal;
a first scaling means (40) for scaling an output signal from a controlled chaos device (30);
a second scaling means (20) for scaling an output signal from the periodic signal generating device (10);
a subtraction means (50) for performing a subtraction operation between the output signals of the first and second scaling means (40) and (20);
an auxiliary scaling means (60) for scaling an output signal from the subtraction means (50) so that a coupling constant for the controlled chaos device (30) and the periodic signal generating device (10) is in a state where chaos is stabilized, and for feeding back the scaled signal to the controlled chaos device (30); and
an inverting means (70) for inverting an output signal from the auxiliary scaling means (60) and feeding back the inverted signal to the periodic signal generating device (10).

3. The apparatus as claimed in claim 1, wherein the first scaling means (40) and the second scaling means (20) perform the scaling such that a ratio of amplitudes of the two input signals is subjected to chaos quenching.

4. The apparatus as claimed in claim 1, wherein the auxiliary scaling means (60) performs the scaling such that a biased signal of the output signal from the subtraction means (50) is subjected to chaos quenching.

5. The apparatus as claimed in claim 1, further comprising:
a first filtering means for filtering out an DC component of the output signal from the controlled chaos device (30); and
a second filtering means for filtering out an DC component of the output signal from the chaos signal generating device (10).

6. The apparatus as claimed in claim 5, wherein the first filtering means and the second filtering means are constructed by serially connecting a differentiator for differentiating the input signals and an integrator for integrating the input signals to each other.

7. The apparatus as claimed in claim 2, wherein the auxiliary scaling means (60) performs the scaling such that a biased signal of the output signal from the subtraction means (50) is subjected to chaos quenching.

8. The apparatus as claimed in claim 2, wherein the first scaling means (40) and the second scaling means (20) perform the scaling such that a ratio of amplitudes of the two input signals is subjected to chaos quenching.

9. The apparatus as claimed in claim 2, further comprising:
a first filtering means for filtering out an DC component of the output signal from the controlled chaos device (30); and
a second filtering means for filtering out an DC component of the output signal from the chaos signal generating device (10).

10. The apparatus as claimed in claim 9, wherein the first filtering means and the second filtering means are constructed by serially connecting a differentiator for differentiating the input signals and an integrator for integrating the input signals to each other.
